(19) United States
(12) Patent Application Publication
(10) Pub. No.: US 2013/0159377 A1
(43) Pub. Date: Jun. 20, 2013

(54) PROACTIVE AUTOMATED PERSONAL ASSISTANT

(71) Applicant: AsystMe, LLC, Waconia, MN (US)

(72) Inventor: Joel Nash, Waconia, MN (US)

(73) Assignee: AsystMe, LLC, Waconia, MN (US)

(21) Appl. No.: 13/717,562

(22) Filed: Dec. 17, 2012

Related U.S. Application Data
(60) Provisional application No. 61/576,051, filed on Dec. 15, 2011.

(51) Int. Cl. H04L 29/08

(52) U.S. Cl. CPC H04L 67/00
USPC 709/202

(57) ABSTRACT

Embodiments relate to a platform for providing information to a user based on the user's context. User context may be determined by the platform and may include the time and date, the user's location, the user's scheduled activities, the users current activities, the user's budget, the weather forecast at the user's location, etc. Agents, software components that may run in the cloud and may perform useful tasks for users, may be created and used by the platform. A topic is a collection of metadata that defines how information is handled in different situations. Topics may be created for and by users, may be associated with events and/or locations, and may be configured to use agents to provide potentially useful information, such as ads, coupons, notifications, and alerts, to users subscribed to the topic.

### CLAIM OF PRIORITY

This patent application claims the benefit of priority, under 35 U.S.C. §119(e), to U.S. Provisional Patent Application Ser. No. 61/576,051, entitled “AUTOMATED PERSONAL ASSISTANT,” filed on Dec. 15, 2011 (Attorney Docket No. 3546.001PRV), which is hereby incorporated by reference herein in its entirety.

### TECHNICAL FIELD

Embodiments pertain to Internet technologies. Some embodiments elate to providing a computing platform for hosting proactive automated personal assistants.

### BACKGROUND

With the proliferation of information available on the Internet, people are increasingly dealing with data overload; at the same time, they are using only a portion of the information that could be useful to them or useful to their smart devices. People interact with their connected world using smartphone apps or a web browser, but these technologies are generally useful only when a person actively initiates an interaction; these technologies generally do not keep a person informed when the person is not looking, nor do they generally allow the person's smart devices to work together. Push technologies deliver information when a person is not actively seeking it, but result in high levels of noise and contributes to data overload.

### BRIEF DESCRIPTION OF THE DRAWINGS

Embodiments are illustrated by way of example and not limitation in the figures of the accompanying drawings, in which like references indicate similar elements and in which:

FIG. 1 illustrates an operational environment of a system supporting proactive automated personal assistants, in accordance with some embodiments;

FIG. 2 illustrates data flow within the system, in accordance with some embodiments;

FIG. 3 is a flowchart of creating and editing of topics within the system, in accordance with some embodiments;

FIG. 4 is a flowchart of the process of selecting and deploying topics within the system, in accordance with some embodiments;

FIG. 5 is a flowchart of an example use case of the system to prepare a user for a workday, in accordance with some embodiments; and

FIG. 6 illustrates a block diagram of an example machine upon which any one or more of the techniques (e.g., methodologies) discussed herein can perform, in accordance with some embodiments.

### DETAILED DESCRIPTION

In the following Detailed Description of example embodiments, reference is made to the drawings, which form a part hereof and in which is shown, by way of illustration, specific embodiments in which the example method, apparatus, and system may be practiced. It is to be understood that other embodiments may be utilized and structural changes may be made without departing from the scope of this description.

There is a need for an approach that, based on a user's context, delivers the information the user needs and no more; this information should be delivered when the user needs it, and how the user needs it. Depending on their situation, a user may need news, suggestions, ads, or offers; they may also want information delivered to their smart devices. Not only could a context-aware push approach benefit users, it could also allow businesses to interact with users who are “receptive now.” Location-aware technologies partially satisfy this need, but location is only one of many facets of a user's context. A user's context may include location, time of day, present activities, scheduled activities, budget, weather, level of busyness, etc. Because there are so many information sources, and because the needs for information may vary greatly depending on the context, there exists complex configuration, context management, and data-handling problems that cannot be addressed by the single-purpose apps that exist today.

Many of the functions performed by embodiments described herein are available as stand-alone applications today. Although these stand-atone applications may provide value to the users 106, they also suffer from several drawbacks. First, each stand-alone application tends to have its own distinct user interface. Second, stand-alone applications generally do not have any means of communicating with each other or sharing data. Third, stand-atone applications generally have no way of working together to bring a greater value than the sum of their parts. Finally, these applications do not take into account what is going on in a user's life, such as the user's location, schedule, or preferences.

Embodiments described herein address these drawbacks by providing a single user interface to all of the exposed functionality and providing a mechanism for the agents to communicate and share data with each other. A system may provide the ability for third party developers to build their own agents, which may be connected to a common platform via APIs (application program interfaces to provide value to users. The result is that users 106 may have a significantly higher value than the sum of the individual apps. In addition, tasks may be performed by the agents based on knowledge of a user's context. User context may be determined by the platform and may be exposed to the agents. User context is also the basis of managing interactions with a user. In various embodiments, user context is used to determine what information a user needs, when a user needs the information, and how to deliver the information to a user.

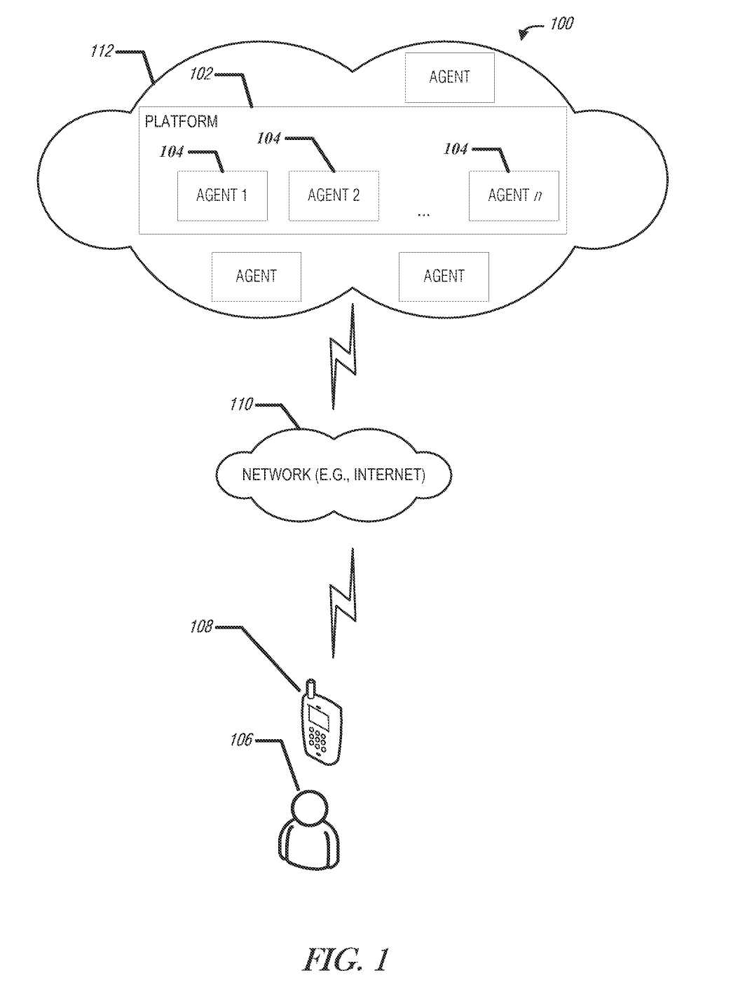

FIG. 1 illustrates an operational environment 100 of a system supporting proactive automated personal assistants, in accordance with some embodiments. Embodiments of the system described herein have three major components: a platform 102, one or more agents 104, and a mobile device 108. In an embodiment, the platform 102 is a software construct running on one or more computers. In an embodiment, the platform 102 executes in a cloud 112. As used herein, cloud architecture (e.g. a cloud) is a logical computing system including one or more virtualization layers between cloud-based applications and hardware components providing processing, memory (i.e., system memory that maintains the state of a currently running computer system), and storage, such as computer servers, storage devices, and network components among other hardware elements. In some examples, the cloud includes a plurality of computer servers to provide processor, memory, and storage resources to a cloud infrastructure virtualization layer. In some examples, the cloud includes one or more cloud platform layers that provide a variety of application programming interfaces (APIs) for cloud-based applications to use the cloud infrastructure. The platform 102 operates as a communication conduit, control unit, and interface between agents 104 or agents 104 and the users 106 via the cloud 112. The platform 102, which may host agents 104, may be built on cloud services such as Amazon Web Services, Google Web Services, Microsoft Azure, or any other cloud-based computing architecture. Computing and storage resources may be dynamically and quickly allocated and unallocated.

A mobile device 108 is a computing device, including but not limited to a mobile phone, a smartphone, personal digital assistant, a laptop computer, or an onboard automobile computer. In an embodiment, an app may run on mobile devices 108 and may act as the primary user interface to the system. The mobile app may be available for a variety of smartphone or tablet platforms. Additionally, user setup and configuration may be performed via a web browser from either a. mobile platform or a desktop platform.

The platform 102 performs a central role in the system. The platform 102 may host agents 104, may allow agents 104 to share data with each other, may interact with the user 106 via the mobile app, may expose a configuration portal, may monitor events, and may conned. with external applications. The platform 102 may manage knowledge of each user's context, and may expose user context to the hosted agents 104. The platform 102 may determine the time(s) and method(s) for notifying a user 106. The platform 102 may be a PaaS (platform as a service) application that may run in the cloud 112.

The platform 102 may manage knowledge of a user's context. User context may be comprised of an extensible collection of “user context elements” that collectively describe a user's context, and may include information that describes what is going on around a user 106. A user's context may include any information that may be relevant for determining overall system behavior; this may include determining what information would be useful for a user 106. The list of user context elements is extensible, and may include:

Present Activity: What the platform determines the user is currently doing,

Busyness level of the user,

Time, date, and day of the week,

Next activity

Present location (as set of coordinates or as a named location (e.g. Disneyland))

Next location

Direction heading

“Checked-in” to a named event

Weather

Personal finances or budget

Social media status

User context elements may be utilized by the platform 102 to determine when and how to notify a user 106. User context elements may be exposed by the platform 102 to agents 104 via APIs so that the agents 104 may operate based on a user's context. For example, a user 106 may want to be awakened from sleep for only very critical information, and may want personal information to be delivered only during personal time. As another example, a user 106 may be interested in an over from a golf course only if the weather forecast is favorable for golfing.

The platform 102 may be responsible for automatically determining, and managing knowledge of a user's 106 context elements. A user's context elements may be based on the user's “baseline schedule,” location, calendar and preferences; other user context elements may be based on data obtained from agents 104 or may be directly inputted by a user 106. A key user context element may be “present activity,” which is a discrete description of what a user 106 is currently doing, such as “sleeping” or “commuting to work.”

A user 106 may configure a “baseline schedule” into the platform 102. The baseline schedule may describe discrete statuses (states) of the user's week such as “sleeping=11 pm-5:30 am,” “getting ready for work=5:30 am-6:30 am,” “commuting to work=6:30 am-7:00 am,” “at work=7:00 am-5:00 pm,” “commuting home=5:00 pm-5:30 pm,” and “personal time=5:30 pm-11:00 pm,” A user 106 may also have sub-states, such as “at work—in meetings.”

If the platform 102 does not have any other information other than a user's baseline schedule, the platform 102 may operate with the present activity context element based on the user's baseline schedule. The platform 102 may override the present activity context element set in a user's 106 baseline schedule if the platform. 102 has access to the user's calendar (such as via Outlook) and/or actual location. A user's location may typically be obtained via a mobile app, which may run on a user's mobile device 108; this app may obtain GPS (Global Positioning System) location information from that mobile device 108. A user 106 may manually set the user's status elements (and override the status elements obtained or calculated by the platform 102) via the app on the user's mobile device 108 or via the platform 102 portal.

The platform 102 may provide the ability for a user 106 to deploy and instantiate an available agent 104. In some situations, a user 106 may deploy multiple instances of an agent 104. In an embodiment, when agents 104 are used to monitor multiple email inboxes, or automobiles, etc., because a single user 106 may have multiple instances of those entities, the user 106 may need one agent 104 for each entity. Users 106 may deploy agents 104 via a mobile device app or via the platform 102 portal.

An agent 104 within the system may have multiple purposes. An agent 104 may generate suggestions for delivery to a user 106. An agent 104 may provide information for deliver to a user 106 or to another agent 104 of the user 106. An agent 104 may provide information that may be used by the platform 102 to calculate context variables. An agent 104 may automate tasks for a user 106 without requiring the user 106 to initiate the task.

Agents 104 are software objects configured to execute in the cloud 112 and perform tasks for or on the behalf of one or more users 106. Agents 104 may be configured to receive data about one or more users' context, learn users' preferences, keep users 106 informed, and collaborate with each other.

An agent 104 may expose its data tags and preferences to the platform 102, so that the platform 102, agent developers, and other agents 104 can access them. An agent 104 may provide the capability for the platform 102 to read its list of preferences and data tags, along with their associated properties. The properties list may include elements such as name, description, type (preference, prompt, storage), permissions required, prompt, data type, control type, size, optional/required, default value, or constraints (list or regular expression).

An agent 104 may have the ability to generate notifications to user mobile devices 108, such as smartphones. The time and method of notification delivery may be determined by the platform 102 and may sometimes be overridden by the agent 104. The default notification delivery time and method may be configured by the user 106. An agent 104 may provide the ability for a user 106 to override those default values for each type of notification capable of being generated by the agent 104.

An agent 104 may have embedded tasks. An agent 104 may expose to the platform 102 the agent's embedded tasks and may provide the platform 102 the capability to run any of the agent's embedded tasks. Some of the functions provided by the agents 104 may be available for calling by the platform 102 on behalf of the user 106. Such tasks may be exposed to the platform 102 so that the platform may expose them and any associated data elements to the mobile device 108 app.

An agent 104 may have the ability to read the data tags available in the platform 102 and determine which of the available data tags correspond to data tags the agent 104 uses. During the installation process of an agent 104, the agent 104 may scan the current pool of data tags available in the platform 102 to identify which of them correspond to data elements that the agent 104 uses. After identifying existing data tags that correspond to data tags the agent 104 uses, the agent 104 may make available the list of its assumed data tag equivalents.

An agent 104 may provide the ability for an administrator to modify the agent's list of data tag equivalents. This may be used, for example, in case the agent 104 made errors in its assumptions. The agent 104 may also highlight those data tags, for which the agent 104 could not find an equivalent, so that an administrator may verify the uniqueness of the data tag or manually set the equivalence of the data tag.

The mobile device app may be the primary facility for interactions between users 106 and agents 104. The app may provide a common user interface for the agents 104 to maintain the same look and feel amongst the agents 104. The mobile device app may also have a background component, which may monitor for alerts or messages from the agents 104 and/or platform 102. The background component may also pass to the platform 102 and to agents 104 data elements updated by the mobile device operating system (OS) or other apps running on the mobile device 108, such as GPS location, mode, calendar, etc. The mobile device app features may respond to touch and voice commands and screens that display data may support text to speech output.

The system 100 may be configured with a plurality of “topics.” A topic is a collection of metadata that defines how information is handled in different situations. Each topic may include the name of the agent(s) 104 that is the source(s) of data and the properties of those agents 104 (e.g. URL of RSS Feed, filters/tagnames, etc.) Each topic may also include the conditions when the topic is active (e.g. when the user 106 is sleeping, when the user 106 is at the mall, etc.) These conditions may be described as a logical (AND/OR) combination of status elements. Each topic may include the duration of time the information specified by the topic should remain relevant. Each topic may include the method(s), by which information specified by this topic should be delivered to the topic subscribers. Each topic may include an importance rating. This may be used by the filtering mechanisms to filter out information based on a user's 106 configuration.

In an embodiment, the platform 102 automatically switches each topic between active or inactive states based on a user's context. Additionally, a user (via the app) may override this automation to set a topic as active or inactive. When a topic is active, user 106 will receive information that is described by that topic, and will receive this information in the form (e.g. audio or text message) specified in that topic. Conversely, when a topic is inactive, the user 106 will not receive the information described in that topic.

Topics may be created by users 106 or agent developers via a portal to the platform 102. Topics are shareable; a user 106 may subscribe to a topic created by someone else. Once subscribed to a topic, a user 106 may override the defaults set for the topic. Topics may be private or public. A public topic may be shared between friends and may be discoverable. Public topics may be discovered by searching a database of topics or may be discovered automatically upon arriving at a location. For example, when arriving at a basketball game the user 106 may be informed, “Topics are available for this location. Do you want to subscribe?” Private topics may be shared between users 106 but are not discoverable. Topics may be shared via email, link, or QR code, as examples. Any public topic may be sponsored by one or more businesses that seek to deliver ads or offers to the users 106 who are actively subscribed to that topic.

If a user 106 subscribes to a topic that specifies the use of an agent 104 that is not currently deployed for that user 106, the platform 102 will automatically deploy and configure the necessary agent 104 for that user 106.

Topics can be grouped (combined) into a “macro topic.” For example, a stretch of road could be a single topic; multiple topics could be combined to cover long stretches of road.

The platform 102 may manage the agents' preference tags, the user 106 preferences for agents 104 they have deployed, and the user preferences for the platform 102. Preferences may be defined when agents 104 are deployed or during the running of agents' processes that may require or allow preferences to be entered, captured, or learned. User preferences may include such items as the user's email addresses, phone numbers, filter and search criteria, message delivery criteria, etc. The stored user preferences may be available to the platform 102, which may manage the exposure of the user tags to the agents 104.

The platform 102 may provide a mechanism to receive and/or store the available preference tags from the installed agents 104. The available tags may be captured at the time of agent installation as well as when an agent 104 is upgraded. There may be three categories of preference tags: required initial value, optional initial value, and learned value.

The platform 102 may make available a list of preference tags from the installed agents 104 as well as platform-related preference tags. This list of tags may be available in real-time for use at design time by developers creating new agents 104.

The platform 102 may capture, store, and/or expose preference values for each user 106, for the deployed agents 104 of each user 106, as well as each user's platform preferences. These preference values may be specified during agent 104 deployment and/or configuration, and may be exposed to other agents 104. The exposing of preference values may be based on permissions established by the user 106.

As a user 106 performs activities on the system 100, the platform 102 may capture and store new or changed user 106 preference values. These new values may be captured as the user 106 responds to agent 104 prompts for preferences. In an embodiment, these preferences may be overridden at run time.

The platform 102 may “learn” new user 106 preferences as a user 106 interacts with the system. For preference tags that an agent 104 may have flagged as “learned value”, the platform 102 may maintain a history of the user's 106 selected values as the user 106 performs activities; the platform 102 may then rate and store the likelihood of each value. This list may then be used by an agent 104 to suggest an appropriate response as well as allow the user 106 to select a value and/or specify not to be prompted again for that preference tag.

The platform 102 may communicate with a database to save new and/or changed preference tag values as processes occur, and may reload stored values during agent 104 initialization.

The platform 102 may manage the relationships between entities (e.g., users 106 and other Objects) associated with agents 104. This may include relationships between people and their family, friends, email accounts, cars, homes, appliances, etc., as well as the data sharing permissions for each such relationship.

The agents 104 and the platform 102 may define the entities that exist in the platform 102. The platform 102 may provide a mechanism to link related entities. The platform 102 may provide a mechanism to grant permissions for data tags and preferences associated with one entity to be accessed by a related entity. The platform 102 may provide a mechanism for an entity to inherit automatically data tag values from a related entity. For example, if a user 106 is in the user's vehicle, then any agent 104 associated with the user's vehicle will inherit the location of the user 106.

The platform 102 may include a response module, which may send agent-generated 104 data to external applications. The platform 102 may also include notification module, which may send notifications to user's mobile devices. The platform 102 may also include a transaction manager, which may manage some or all financial transactions in the system 100. The platform 102 may also include an event module, which may read events and event data from queues, may store event data in a database, may retrieve and merge data tag and preference data, and may publish event data. The platform 102 may also include a future event monitor, which may monitor a database for events scheduled to run at a future time, and submit an event to the event pre-processor module when the event's scheduled time is reached. The platform 102 may also include an event pre-processor module, which may receive events from the mobile devices, external applications, and the future event monitor, and may load these events into the processing queue. The platform 102. may also include a post-processor module, which may receive data and messages returned from agents 104, may apply filters and preferences to determine if and when to deliver a notification, may route the notification to the proper outbound message processor, and may store agent-generated 104 and any scheduled events to the database. Consequently, the system 100 may automate tasks for users 106, reduce users' data overload, and leverage the Internet 110 to improve users' personal productivity.

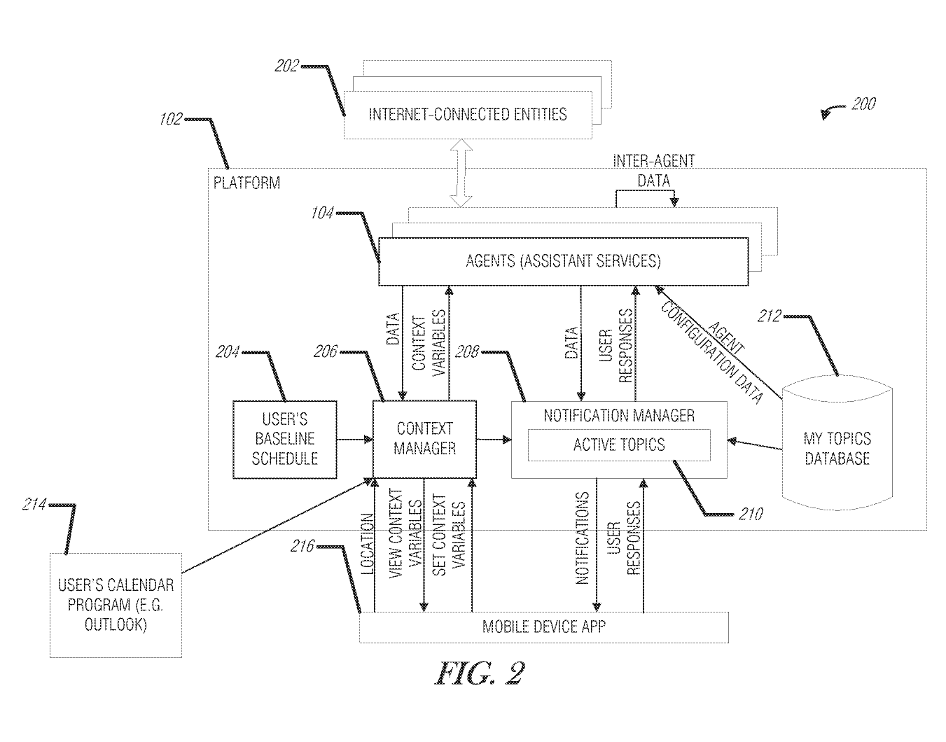

FIG. 2 illustrates data flow 200 within the system, in accordance with some embodiments. A user 106 may have multiple internet-connected entities 202. An entity is an object used by a user and connected or connectable to a network. Entities may be physical objects or virtual objects. Examples of entities include, but are not limited to an email account, an automobile, or a coffee maker. For each of a user's 106 internet-connected entities 202, an agent 104 may be hosted in the platform 102. An agent 104 performs services related to its internet-connected entity 202 on behalf of user 106. An agent 104 may communicate with other agents 104.

A user 106 may configure a “baseline schedule” 204 into the platform 102. The baseline schedule 204 may describe discrete statuses (states) of the user's 106, week such as “sleeping=11 pm-5:30 am,” “getting ready for work=5:30 am-6:30 am,” “commuting to work=6:30 am-7:00 am,” “at work=7:00 am-5:00 pm,” “commuting home=5:00 pm-5:30 pm,” and “personal time=5:30 pm-11:00 pm.” A user 106 may also have sub-states, such as “at work in meetings.”

A context manager 206 may be responsible for monitoring user schedules, locations, etc., to determine each user's context variables. A mobile device app 216 running on a user's mobile device 108 may provide a context manager 206 with data, such as the location of the mobile device 108 or context variables input by a user 106. The context manager 206 may use these context variables, along with the baseline schedule 204 of each user 106, data from a user's calendar program 214, and data received from agents 104 to determine the user context of one or more users 106. The context manager 206 may provide these context variables to the agents 104, and to a user's mobile device app 216, which may display the context variables to the user 106 and may allow the user 106 to modify the context variables.

A notification manager 208 may be responsible for determining when and how to notify a user 106. The notification manager 208 may also be responsible for receiving user responses to notifications, and may relay user responses to the agents 104. The notification manager may maintain a list of active topics 210, and may use this list of active topics 210 to determine when and how to notify a user subscribed to an active topic 210.

Instances of My Topics Database 212 may store topics, to which a user 106 is subscribed. Instances of My Topics Database 212 may send agent configuration data to the agents 104, to configure the agent(s) associated with a topic. The notification manager 208 may receive data from the My Topics Database 212 instances, and may use this data to determine the list of active topics 210.

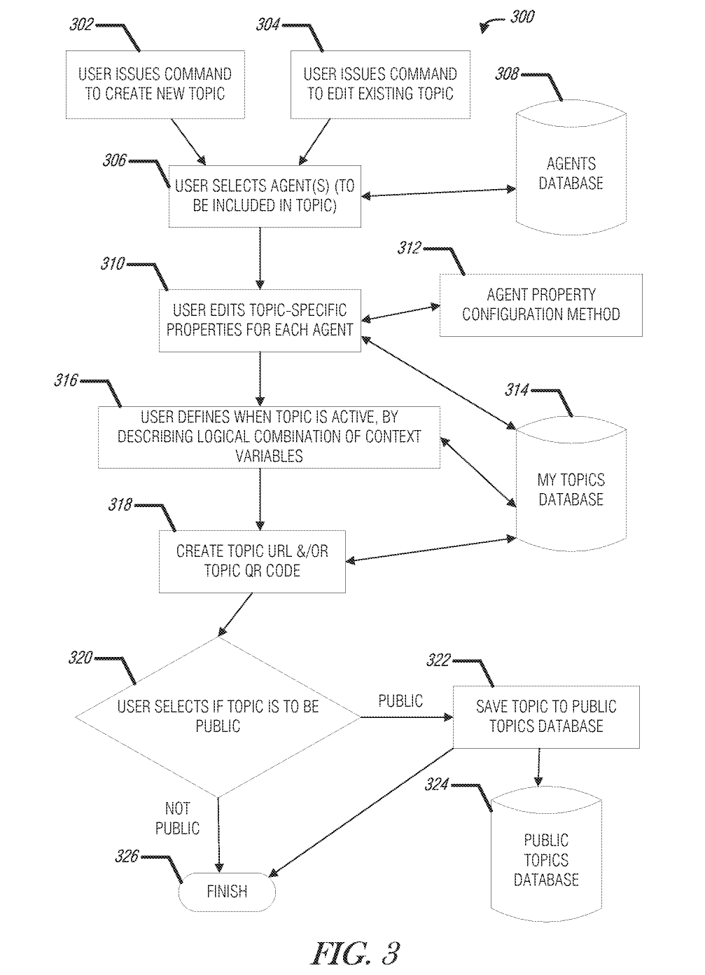

FIG. 3 is a flowchart of creating and editing of topics within the system, in accordance with some embodiments. A user 106 may issue a command to create a new topic (block 302). If the user 106 has permissions to edit a topic, the user 106 may issue a command to edit the existing topic (block 304). The user 106 may then select which agent(s) 104 should be included in the topic (block 306). In an embodiment, a list of available agents 104 may be retrieved from an agent database 308. The user 106 may then edit topic-specific properties for each agent 104 selected for the topic (block 310), and an agent property configuration method may update the properties for the agent 104 (block 312). The user 106 may then define when the topic is active, by describing logical combinations of context variables (block 316). For example, user 106 may define a topic to be active when commuting or not in a meeting. The topic may then be saved into the user's topics database 314.

If the user 106 desires to share the topic with other users 106, the user 106 may create a topic URL or QR code (block 318); the URL or QR code for the topic may also be saved with the topic in the user's topics database 314. The user 106 may then decide whether to make the topic public (block 320). Public topics may be discoverable by other users 106, while non-public topics may not be discoverable by other users 106. If the user 106 decides to make the topic public, then the topic may be saved to a public topics database 324 (block 322). Alternatively, if the user 106 decides to make the topic nonpublic, the process of creating and/or editing the topic may finish (block 326).

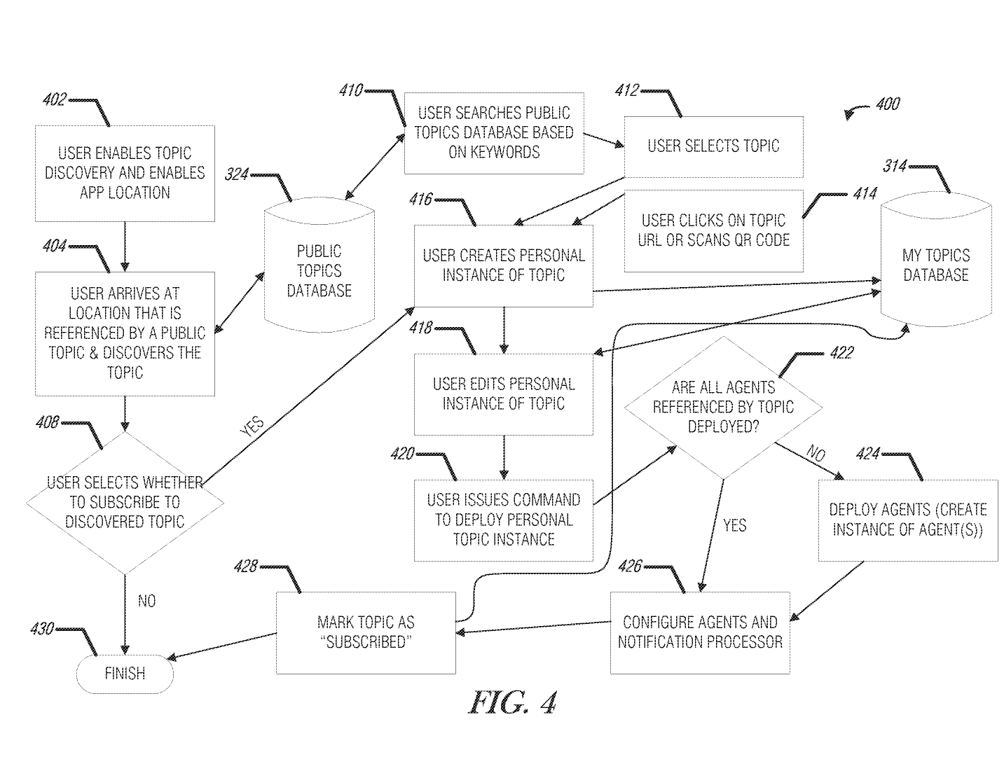

FIG. 4 is a flowchart of the process 400 of selecting and deploying topics within the system, in accordance with some embodiments. A user 106 may discover and subscribe to topics in a number of ways. A user 106 may discover a topic, search for a topic, be sent a URL for the topic, or scan a QR code for the topic.

In some embodiments, a user 106 may enable topic discovery and app location on the user's mobile device 108 (block 402). The user 106 may then arrive at a location that is referenced by a public topic, and may discover the public topic via the mobile device app 216 (block 404). The user 106 may then select whether to subscribe to the discovered topic (block 408). If the user 106 selects not to subscribe to the discovered topic, the process finishes (block 430).

In some embodiments, the user 106 may search a public topics database 324 for a topic (block 410). The search may be based on keywords. After finding a topic, user 106 may select the topic (block 412).

In some embodiments, user 106 may receive a URL for the topic or may scan a QR code for the topic.

Regardless of the mechanism (discovery, searching, URL or QR code) by which the user 106 finds the topic, once the user 106 subscribes to the topic, the user 106 may create a personal instance of the topic (block 416). The user 106 may then edit the personal instance of the topic (block 418). The personal instance of the topic may be stored in the user's My Topics Database 314.

After editing the personal instance of the topic, the user 106 may issue a command to deploy the personal topic instance (block 420). The platform 102 may then determine if all agents 104 referenced by the topic are deployed for the user 106 (block 422). If the platform 102 determines that not all agents 104 referenced by the topic are deployed for the user 106, the platform 102 may create instances of the referenced agents 104 and deploy the created agent instances 104 on behalf of the user 106 (block 424). T platform 102 may then configure the created agent instances 104 and the platform's notification processor (block 426). If the platform 102 determines that all agents 104 referenced by the topic are deployed for user 106, the platform 102 may configure the agent instances 104 and the platform's notification processor without creating additional agent instances.

After the agents 104 and notification processor have been configured at block 426, the platform 102 may mark the topic as “subscribed” for the user 106 (block 428). The selection and deployment process 400 may then finish (block 430).

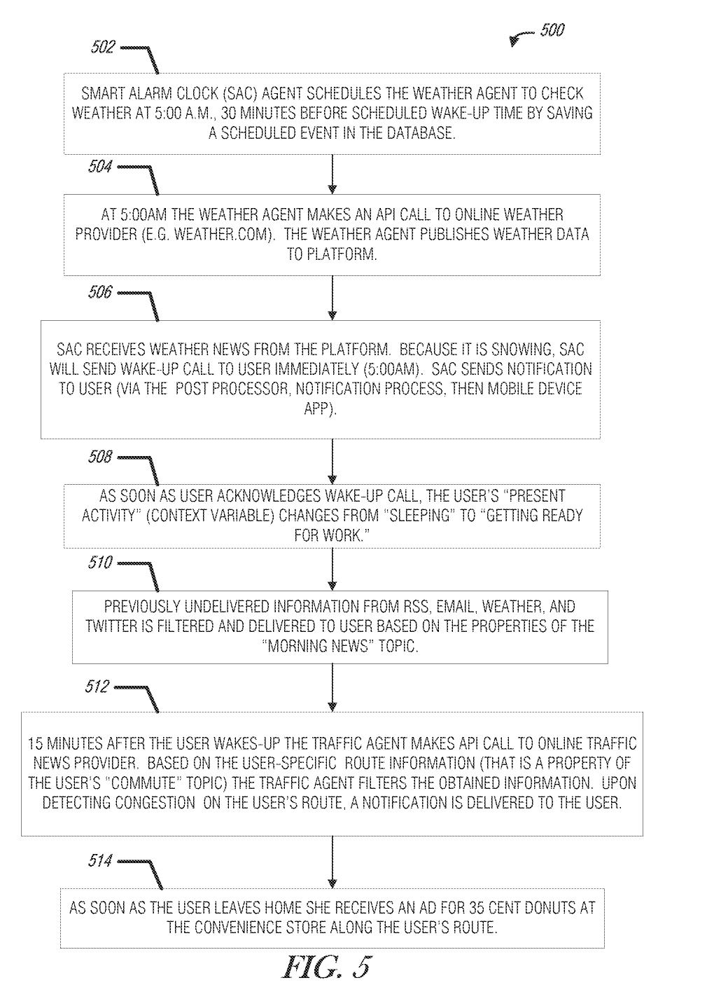

FIG. 5 is a flowchart of an example use case 500 of the system to prepare a user for a workday, in accordance with some embodiments. A user 106 may have a Smart Alarm Clock (SAC) agent and a weather agent deployed for the user 106. At block 502, the SAC agent schedules the weather agent to check the weather at 5:00 A.M., 30 minutes before the scheduled wake-up time of 5:30 A.M. for user 106. The SAC agent may do this by saving a scheduled event in the database.

At block 504, the weather agent makes an API call to an online weather provider (e.g., Weather.com) at 5:00 A.M. The weather agent publishes the weather data received from the online weather provider to the platform 102.

At block 506, the SAC agent receives weather news from the platform 102. Because it is snowing, the SAC agent will send a wake-up notification to the user 106 immediately (e.g. at 5:00 A.M.). If it had not been snowing, the wake-up notification would have been sent at 5:30 A.M., the regular scheduled wake-up time for user 106. The SAC agent sends a wake-up notification to user 106 via the post-processor, then the notification manager 208, and then mobile device app 216.

At block 508, when the user 106 acknowledges the wake-up notification, the user's “present activity” context variable changes from “sleeping” to “getting ready for work.”

At block 510, previously undelivered information from the user's 106 RSS, email, weather, and Twitter agents is filtered and delivered to user 106 based on the properties of the “morning news” topic, to which user 106 is subscribed.

At block 512, 15 minutes after user 106 received the wake-up notification, a traffic agent makes an API call to an online traffic news provider. Based on the user-specific route information (that is a property of the user's 106 “commute” topic) the traffic agent filters the obtained information. Upon detecting congestion on the user's route, a notification is delivered to the user 106, informing user 106 of the traffic congestion.

At block 514, after the user 106 leaves home, the user 106 receives an ad for 35-cent donuts at the convenience store along user's route. The advertisement may be from the SAC agent, the traffic agent, or from another agent.

### ADDITIONAL EXAMPLES

In one example, the user has topic discovery turned on. Another user has created a public topic called “Mytown Football” for the local high school's football games. This topic is active when the user is at the stadium or otherwise “checked-in.” This topic specifies data from the following agents: RSS and Twitter and keywords or hashtags that are specific to the game. This topic specifies that information be delivered as text. This topic is sponsored by the local Dairy Queen and local Hardware Hank. The user previously utilized the RSS agent but did not previously utilize the Twitter agent.

As user arrives at the stadium, he receives a notification that a topic “Mytown Football” is available for that location. He is asked if he wants to subscribe to that topic. The user subscribes to the Mytown Football topic. Since this topic specifies use of the previously unused Twitter agent, the platform automatically deploys the Twitter agent and sends the topic's properties (filters, keywords, etc.) to the RSS agent and the Twitter agent. During the course of the game, the user receives Twitter tweets, blog posts and other news based pm the properties of the Mytown Football topic. Some of the notifications received during the game are ads or offers from the local Dairy Queen (such as $1 off blizzards until 10:00 P.M.) and Hardware Hank. As soon as the user leaves the stadium, the Mytown Football topic becomes inactive.

In another example, the user has previously subscribed to a “Timber Creek Golf” topic by scanning a QR Code created by the golf course. This topic is active when the user is in town, at work, and does not have anything on his calendar. This topic specifies data from the CRS (customer relationship services) agent. This topic specifies that information be delivered as text.

The golf course receives a call that a golfer has canceled her 2:00 P.M. tee time. The golf course manager opens the CRS (customer relationship services) portal and sees that 10 customers are actively subscribed to the “Timber Creek Golf” topic. The manager then creates a discount offer notification and selects “send.” A golf course customer receives the tee-time offer notification and selects “accept.” Via the CRS portal, the golf course manager is informed of the name of the person who has accepted the offer.

In another example, the user has deployed a “Home Automation” agent. This agent subscribes to user location data from the platform. The user has deployed a “Smart Coffee maker” agent. This agent subscribes to wake-up time data from the platform (which is generated by the Smart Alarm Clock agent).

Thirty minutes before the user receives a wake-up call, Smart Alarm Clock agent publishes the wake-up time to the platform. Ten minutes before the user is to wake-up Smart Coffee Maker agent starts the coffee pot. As the last person leaves the home in the morning, the platform delivers user location data to the Home Automation agent, which changes the home thermostat to save energy. When the homeowner leaves work for home, the platform delivers user location data to the Home Automation agent, which changes the home thermostat to maximize user comfort before the user arrives.

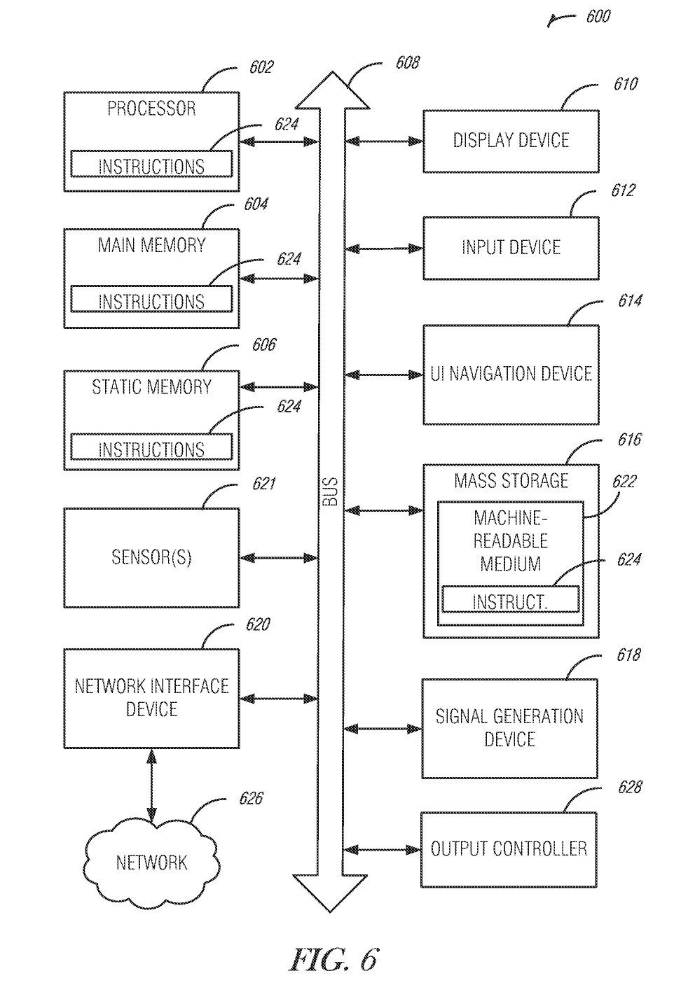

FIG. 6 illustrates a block diagram of an example machine 600 upon which any one or more of the techniques (e.g., methodologies) discussed herein can perform. In alternative embodiments, the machine 600 can operate as a standalone device or can be connected (e.g., networked) to other machines. In a networked deployment, the machine 600 can operate in the capacity of a server machine, a client machine, or both in server-client network environments. In an example, the machine 600 can act as a peer machine in peer-to-peer (P2P) (or other distributed) network environment. The machine 600 can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate on, logic or a number of components, modules, or mechanisms. Modules are tangible entities capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client or server computer system.) or one or more hardware processors can be configured by firmware or software (e.g., instructions, an application portion, or an application) as a module that operates to perform specified operations. In an example, the software can reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor can be configured as respective different modules at different times. Software can accordingly configure a hardware processor, for example, to constitute a particular module at one instance of time and to constitute a different module at a different instance of time.

Machine (e.g., computer system) 600 can include a hardware processor 602 (e.g., a central processing unit (CPU), a graphics processing unit (GPU), a hardware processor core, or any combination thereof), a main memory 604, and a static memory 606, some or all of which can communicate with each other via a bus 608. The machine 600 can further include a display unit 610, an alphanumeric input device 612 (e.g., a keyboard), and a user interface (UI) navigation device 614 (e.g., a mouse). In an example, the display unit 610, input device 612 and UI navigation device 614 can be a touch screen display. The machine 600 can additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 can include an output controller 628, such as a serial (e.g., universal serial bus (USB), parallel, or other wired or wireless (e.g., infrared (IR)) connection to communicate or control one or more peripheral devices e.g., a printer, card reader, etc.).

The storage device 616 can include a machine-readable medium 622 on which is stored one or more sets of data structures or instructions 624 (e.g., software) embodying or utilized by any one or more of the techniques or functions described herein. The instructions 624 can also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 can constitute machine-readable media.

While the machine-readable medium 622 is illustrated as a single medium, the term “machine-readable medium” can include a single medium or multiple media (e.g., a centralized or distributed database, and/or associated caches and servers) that configured to store the one or more instructions 624.

The term “machine-readable medium” can include any tangible medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples can include solid-state memories, and optical and magnetic media. Specific examples of machine-readable media can include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 can further be transmitted or received over a communications network 626 using a transmission medium via, the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, among others. In an example, the network interface device 620 can include one or more physical jacks (e.g., Ethernet, coaxial, or phone jacks) or one or more antennas to connect to the communications network 626. In an example, the network interface device 620 can include a plurality of antennas to communicate wirelessly using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. In addition, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system comprising:
a platform for maintaining a user context;
a plurality of agents communicatively coupled to the platform; and
a user device communicatively coupled to the platform,
wherein the platform is configured to provide communication between the user device and at least one of the plurality of agents, and
wherein at least one agent is configured to:
access the platform;
obtain the user context; and
provide information to the user device, via the platform, related to the user context.
